(19) United States
(12) Patent Application Publication
(10) Pub. No.: US 2023/0385610 A1
(43) Pub. Date: Nov. 30, 2023

(54) INDOOR PASSIVE HUMAN BEHAVIOR RECOGNITION METHOD AND DEVICE

(71) Applicant: NANJING UNIVERSITY OF POSTS AND TELECOMMUNICATIONS, Nanjing (CN)

(72) Inventors: Dengyin ZHANG, Nanjing (CN); Yonglian MA, Nanjing (CN); Songhao LU, Nanjing (CN); Dingxu GUO, Nanjing (CN)

(21) Appl. No.: 18/331,887

(22) Filed: Jun. 8, 2023

Related U.S. Application Data
(63) Continuation of application No. PCT/CN2023/095306, filed on May 19, 2023.

(30) Foreign Application Priority Data
Aug. 24, 2022 (CN) 202211023957.9

(51) Int. Cl. G06N 3/0464

(52) U.S. Cl. CPC G06N 3/0464

(57) ABSTRACT

Disclosed are an indoor passive human behavior recognition method and device. The method includes the following steps: dividing an indoor activity space into multiple regions, collecting a channel impulse response data packet of a reflection signal of each activity in each region to obtain an H (M, N, Z) matrix; preprocessing the H (M, N, Z) matrix to obtain a preprocessed H (M, N, Z) matrix; extracting features of the preprocessed H (M, N, Z) matrix to obtain a training sample of a convolutional neural network model; performing transfer learning on the convolutional neural network model using the training sample to obtain a trained convolutional neural network model; obtaining an indoor channel impulse response amplitude value, inputting the channel impulse response amplitude value into the trained convolutional neural network model, and outputting a human behavior.

### TECHNICAL FIELD

The present disclosure relates to an indoor passive human behavior recognition method and device, belonging to the technical field of information processing.

### BACKGROUND

The rapid development of Internet of Things technology has promoted the connection between people and things and between things and things, and greatly changed the way of life of human beings. Human behavior recognition, as one of the important research hotspots in the intelligent field of Internet of Things, brings a great convenience to the life of people. A variety of intelligent systems have been applied to various regions of life, and a typical application is the fall detection system specially designed for the elderly living alone.

Various sensors, such as physical sensors, cameras, etc. are used for traditional human behavior recognition. However, in recent years, with the rapid development of wireless networks, the role of radio frequency signals has expanded from a single communication medium to a non-invasive environmental sensing tool. The use of wireless signals for human behavior recognition frees the wearing restrictions for the users and has broad development prospects. Its basic principle is that radio frequency signals propagate in wireless media through multiple paths to reflect different objects and reach the receiver, and thus the radio frequency signals carry information of the related environment. As human body is a good reflector, by analyzing patterns and characteristics of the received RF signal, human activities and behavior states, such as breathing rate, gestures and falls, can be detected.

In recent years, deep learning, which has been widely concerned, has been successfully applied to speech recognition, graphic recognition and other fields. Features can be extracted from indoor environment wireless signals through deep learning, such that human activity recognition can be carried out. Transfer learning solves the phenomenon of over-fitting caused by using a redundant data training model, but the CNN (convolutional neural network) model based on transfer learning algorithm with MMD (maximum mean discrepancy) as the measurement index still has the problem of low recognition accuracy, the reason is that the data received in error has the same distribution when there are differences in data distribution.

How to improve the accuracy of human behavior recognition using a radio frequency signal is an urgent technical problem to be solved by those skilled in the art.

### SUMMARY

Objective: In order to overcome the disadvantages in the prior art, an indoor passive human behavior recognition method and device are provided.

Technical solution: In order to solve the technical problems above, the present disclosure employs the technical solutions as follows:

In a first aspect, an indoor passive human behavior recognition method based on transfer learning includes the following steps:
Step 1: dividing an indoor activity space into a plurality of regions, collecting a CIR (channel impulse response) data packet of a reflection signal of each activity in each region to obtain an H (M, N, Z) matrix, wherein M denotes a region number, N denotes a human activity type, and Z denotes the CIR data packet;
Step 2: preprocessing the H (M, N, Z) matrix to obtain a preprocessed H (M, N, Z) matrix;
Step 3: extracting features of the preprocessed H (M, N, Z) matrix to obtain a training sample of a CNN (convolutional neural network) model;
Step 4: performing transfer learning on the CNN model using the training sample, so as to obtain a trained CNN model; and
Step 5: obtaining an indoor CIR amplitude value, inputting the CIR amplitude value into the trained CNN model, and outputting a human behavior.

As a preferred solution, a calculation formula for the CIR is as follows:

H(i)=∥H(i)∥e^{j∠H(i)}

where H(i) denotes channel state information of an i-th sub-carrier, ∥H(i)∥ denotes an amplitude of the i-th sub-carrier, ∠H(i) denotes a phase of the i-th sub-carrier, and j is an imaginary part of a complex number.

As a preferred solution, an acquisition method for the region number is as follows:
dividing the activity space into M regions with the same area and in a n×n distribution, and starting from the top left corner, numbering the regions in each row from left to right in turn.

As a preferred solution, Step 2 includes the following steps:
filtering the CIR data packet of the H (M, N, Z) matrix using hampel, so as to obtain a filtered H (M, N, Z) matrix;
interpolating the CIR data packet of the filtered H (M, N, Z) matrix to obtain an interpolated H (M, N, Z) matrix;
preforming Kalman smoothing filtering on the CIR data packet of the interpolated H (M, N, Z) matrix to obtain a smoothed H (M, N, Z) matrix;
performing wavelet transform on the CIR data packet of the smoothed H (M, N, Z) matrix to obtain a denoised H (M, N, Z) matrix; and
performing data dimension reduction processing on the CIR data packet of the denoised H (M, N, Z) matrix using PCA (Principal Component Analysis), so as to obtain a dimension-reduced H (M, N, Z) matrix.

As a preferred solution, Step 3 includes the following steps:
clustering CIR amplitude values of various regions for various activities to obtain n major types;
dividing the M regions for various activities into n major types;
calculating MKMMD (Multiple Kernel Maximum Mean Discrepancy) values of the CIR amplitude values of various regions for each type of activity, and obtaining a number of a region corresponding to the minimum MKMMD value;
acquiring a number of a region corresponding to a human reflection path from the regions corresponding to the minimum MKMMD values in various types of activity according to the wireless sensing principle of a Fresnel zone;
using a CIR amplitude value of the region corresponding to the human reflection path of each type of activity as a first training sample; and
using CIR amplitude values corresponding to the remaining numbered regions for various activities as a second training sample.

As a preferred solution, Step 4 includes the following steps:
training the CNN model using the first training sample, so as to obtain initial parameters of the CNN model; and
substituting the initial parameters of the CNN model into the CNN model, freezing parameters of a convolution layer and a pooling layer before a fully connected layer of the CNN model, and then selecting a certain number of second training samples to form secondary training data to train the fully connected layer of the CNN model, thus obtaining a trained CNN model.

As a preferred solution, the CNN model includes three convolution layers, a pooling layer is connected after each convolution layer, output ends of all pooling layers are connected with two fully connected layers after fusion calculation; a Dropout layer is connected after the last fully connected layer, and a softmax layer is connected after the Dropout layer.

In a second aspect, an indoor passive human behavior recognition device based on transfer learning includes the following modules:
a collection module, configured to divide an indoor activity space into a plurality of regions, collecting a CIR data packet of a reflection signal of each activity in each region to obtain an H (M, N, Z) matrix, where M denotes a region number, N denotes a human activity type, and Z denotes the CIR data packet;
a preprocessing module, configured to preprocess the H (M, N, Z) matrix to obtain a preprocessed H (M, N, Z) matrix;
a training sample acquisition module, configured to extract features of the preprocessed H (M, N, Z) matrix to obtain a training sample of a CNN model;
a CNN training module, configured to perform transfer learning on the CNN model using the training sample, so as to obtain a trained CNN model; and
a behavior recognition module, configured to obtain an indoor CIR amplitude value, input the CIR amplitude value into the trained CNN model, and output a human behavior.

The present disclosure has the beneficial effects that in accordance with an indoor passive human behavior recognition method and device provided by the present disclosure, a MIMO (Multiple-Input Multiple-Output) technology is employed, which can greatly improve system throughput without increasing frequency spectrum resources and antenna transmitting power, thereby improving communication quality. Moreover, the amplitude of CIR signals and phase difference information brought by multiple antennas can be fully utilized. DWT (Discrete Wavelet Transform) can be used to provide high temporal resolution when the activity frequency is high. When the activity is slow, high frequency resolution may also be provided. In addition, the DWT can be used to calculate different levels of signal energy corresponding to different frequency ranges. The optimal subcarrier can be effectively reduced using PCA (principal component analysis), so as to achieve the goal of dimension reduction. The problems of fewer samples and poor training efficiency can be solved by using statistical features, MKMMD (Multiple Kernel Maximum Mean Discrepancy) and a CNN network model training method which combines a sample classification method based on the wireless sensing principle of the Fresnel zone with the transfer learning. The method and device disclosed by the present disclosure are simple in detection equipment, low-cost, excellent in privacy, and good in recognition effect.

### BRIEF DESCRIPTION OF THE DRAWINGS

FIG. 1 is an implementation flow chart of a method in accordance with the present disclosure;

FIG. 2 is a schematic diagram of indoor propagation of a signal in accordance with the present disclosure;

FIG. 3 is a schematic diagram of region division in a room during the implementation of the method in accordance with the present disclosure;

FIG. 4 is diagram illustrating a final result of signal preprocessing;

FIG. 5 is a box plot of a CIR amplitude distribution.

### DETAILED DESCRIPTION OF THE EMBODIMENTS

The present disclosure is further described below with reference to the accompanying drawings and embodiments.

In a first embodiment, an indoor passive human behavior recognition method based on transfer learning includes the following steps.

Step 1: An indoor activity space is divided into multiple regions, a CIR data packet of a reflection signal of each activity in each region is collected to obtain an H (M, N, Z) matrix, where M denotes a region number, N denotes a human activity type, and Z denotes the CIR data packet.

Step 2: The H (M, N, Z) matrix is preprocessed to obtain a preprocessed H (M, N, Z) matrix.

Step 3: Features of the preprocessed H (M, N, Z) matrix are extracted to obtain a training sample of a CNN model.

Step 4: The training sample is used to perform transfer learning on the CNN model, so as to obtain a trained CNN model.

Step 5: An indoor CIR amplitude value is obtained, the CIR amplitude value is input into the trained CNN model, and then a human behavior is output.

In a second embodiment, an indoor passive human behavior recognition device based on transfer learning includes the following modules:
a collection module, configured to divide an indoor activity space into a plurality of regions, collecting a CIR data packet of a reflection signal of each activity in each region to obtain an H (M, N, Z) matrix, wherein M denotes a region number, N denotes a human activity type, and Z denotes the CIR data packet;
a preprocessing module, configured to preprocess the H (M, N, Z) matrix to obtain a preprocessed H (M, N, Z) matrix;
a training sample acquisition module, configured to extract features of the preprocessed H (M, N, Z) matrix to obtain a training sample of a CNN model;
a CNN training module, configured to perform transfer learning on the CNN model using the training sample, so as to obtain a trained CNN model; and
a behavior recognition module, configured to obtain an indoor CIR amplitude value, input the CIR amplitude value into the trained CNN model, and output a human behavior.

### Embodiment

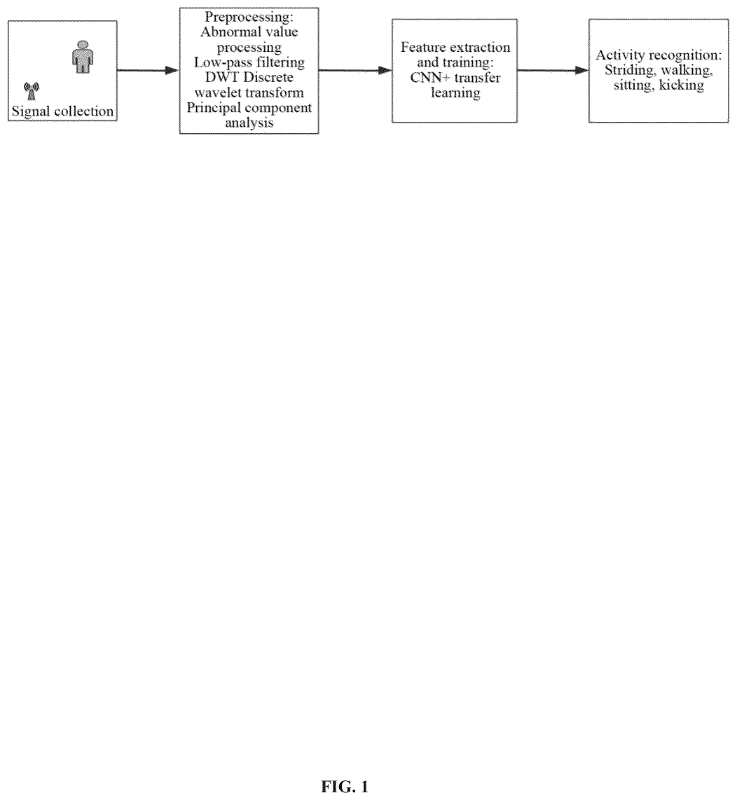

As shown in FIG. 1, an indoor passive human behavior recognition method based on transfer learning includes the following steps:

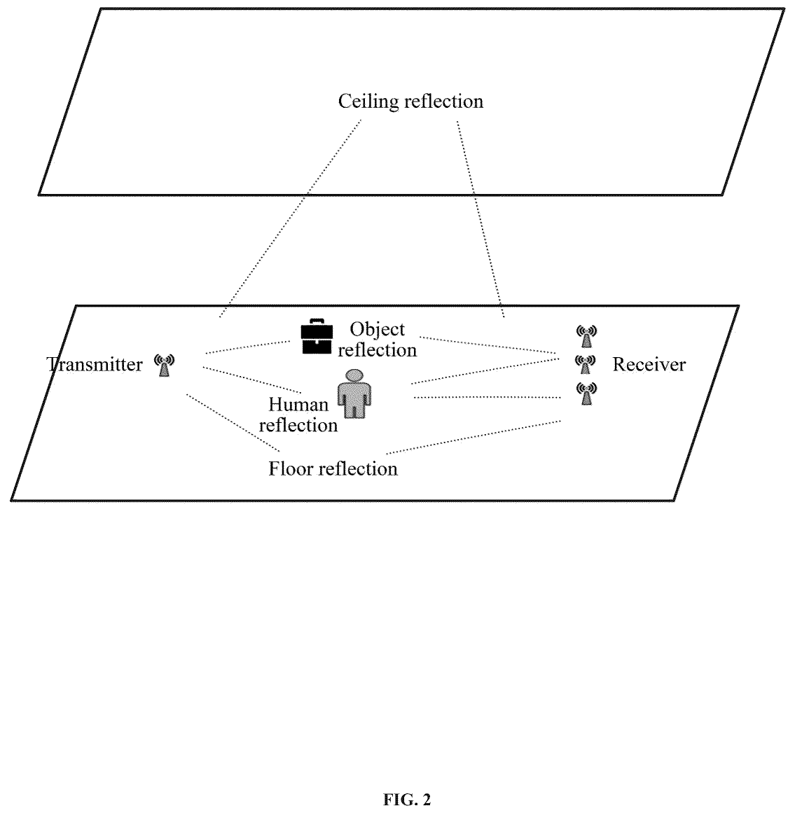

Step 1: As shown in FIG. 2, one transmitter and three receivers are arranged at both ends of the room at a height of about 1.2 m from the ground. An antenna array using the MIMO (multi-input multi-output) technology is used to collect a reflection signal in the room.

An indoor activity space is divided into multiple regions, a CIR data packet of a reflection signal of each activity in each region is collected to obtain an H (M, N, Z) matrix, where M denotes a region number, N denotes a human activity type, and Z denotes the CIR data packet.

The CIR data packet represents a Channel Impulse Response (CIR) to describe the multi-path effect of the channel.

Channel impulse response refers to a signal energy value when the signal arrives at a receiver after different times. A calculation formula for the channel impulse response is as follows:

H(i)=∥H(i)∥e^{j∠H(i)}

where H(i) denotes channel state information of an i-th sub-carrier, ∥H(i)∥ denotes an amplitude of the i-th sub-carrier, ∠H(i) denotes a phase of the i-th sub-carrier, and j is an imaginary part of a complex number.

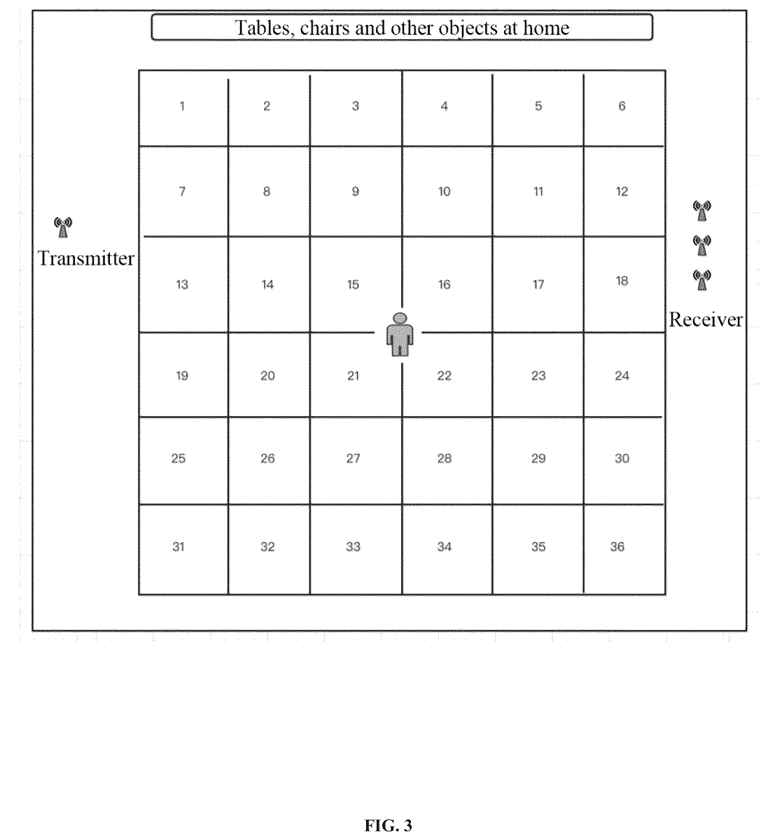

As shown in FIG. 3, except for the region in the room where the furniture is located, the activity space is divided into 36 regions with the same region and in a 6×6 distribution. Starting from the top left corner, the regions in each row are numbered from left to right.

Step 2: The H (M, N, Z) matrix is preprocessed to obtain a preprocessed H (M, N, Z) matrix.

The CIR data packet of the H (M, N, Z) matrix is filtered using hampel to obtain a filtered H (M, N, Z) matrix, such that abnormal values in the CIR data packet are removed.

The CIR data packet of the filtered H (M, N, Z) matrix is interpolated to obtain an interpolated H (M, N, Z) matrix, thereby guaranteeing that the CIR data packet is not lost at the receiver.

The CIR data packet of the interpolated H (M, N, Z) matrix is subjected to Kalman smoothing filtering to obtain a smoothed H (M, N, Z) matrix.

The CIR data packet of the smoothed H(M, N, Z) matrix is subjected to wavelet transform to obtain a denoised H (M, N, Z) matrix.

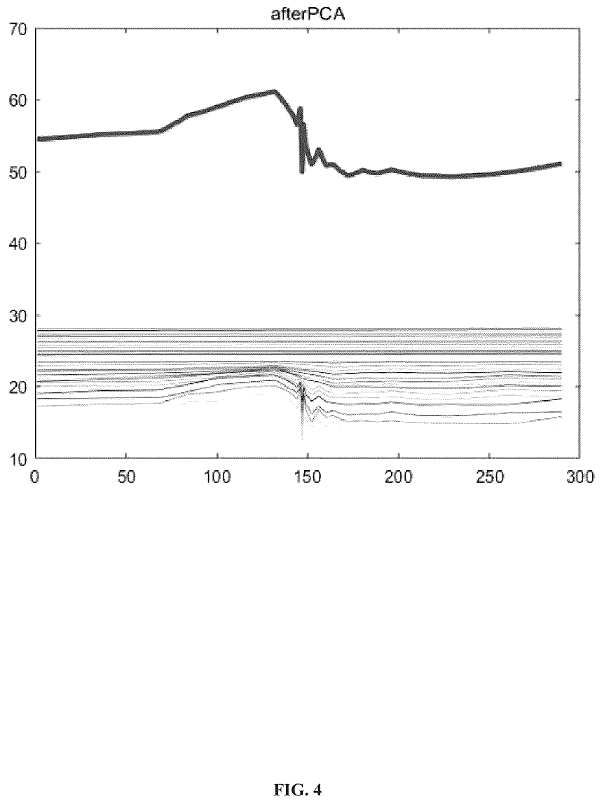

As shown in FIG. 4, PCA (Principal Component Analysis) is used to perform data dimension reduction on the CIR data packet of the denoised H (M, N, Z) matrix to obtain a dimension-reduced H (M, N, Z) matrix.

Step 3: Features of the dimension-reduced H (M, N, Z) matrix are extracted to obtain a training sample of the CNN model.

In order to eliminate the interference of environment on the human activity recognition, the whole room is divided into M=36 (6×6) regions in equal proportion, and each activity of an experimenter is collected in each region, and the activity type is N=4, which are striding, walking, sitting and kicking, respectively. The four activity types are marked as actions a, b, c and d, and so on. The first sitting action collected in a sixteenth region can be marked as 16c1, which is convenient for memory and not easy to be confused.

The H (M, N, Z) matrix is processed by statistical features, MKMMD (Multiple Kernel Maximum Mean Discrepancy) and the wireless sensing principle based on Fresnel zone, thus obtaining the training samples of the CNN model.

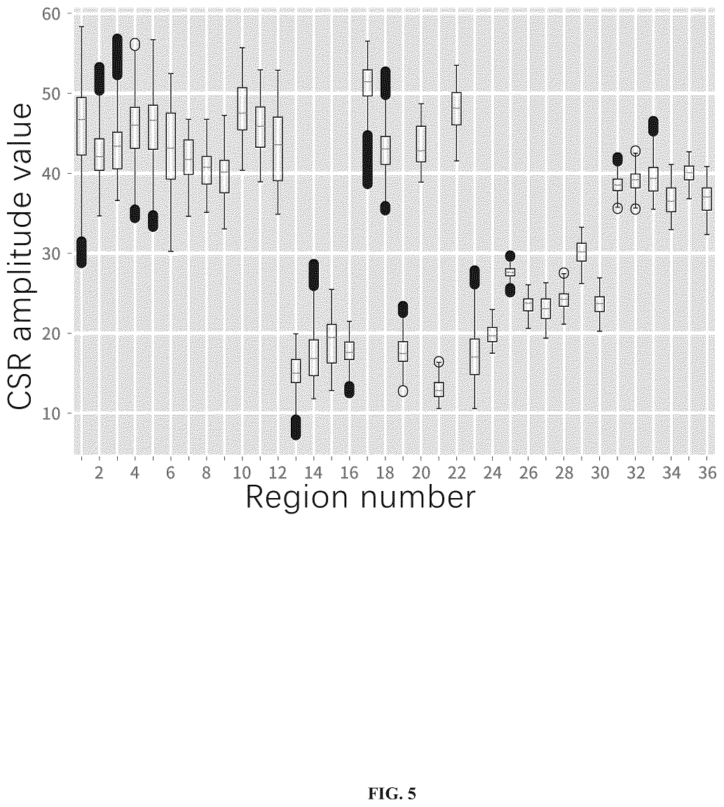

It is known that the environment may have a multipath effect on the propagation of signals. Even the same action is made in different regions in the same room, the collected CIR data may be different. For different actions in the same region, as the actions have different characteristics, the actions are classified through the collected COR in this embodiment. In order to minimize the impact of environment on the human activity recognition and improve the reusability of the whole system, the focus is on how similar the received signals of the same action in different regions are. As shown in FIG. 5, the box plot is used to show the CIR amplitude distribution when the activity type is “sitting” in a first region to a 36th region, revealing the difference of CIR data distribution of the same action in different regions. Although it is difficult to represent the same activity in different regions using statistical features, it can be intuitively seen from the box plot that adjacent regions have similar statistical features.

According to the results of the statistical characteristics, the thirty-six regions are first divided into three major types according to the statistical characteristics of the CIR amplitude values of sitting, and the difference between the CIR amplitude values of adjacent types of regions is within a set threshold value. The region numbers in FIG. 5 are recorded as: {1, 2, 3, 4, 5, 6, 7, 8, 9, 10, 11, 12, 31, 32, 33, 34, 35, 36}, {17, 18, 20, 22}, {13, 14, 15, 16, 19, 21, 23, 24, 25, 26, 27, 28, 29, 30}.

A MKMMD value of the CIR amplitude value of each region in each type is calculated to obtain a number of a region corresponding to the minimum MKMMD value.

A number of a region corresponding to a human reflection path is acquired from the regions corresponding to the minimum MKMMD value in each type according to the wireless sensing principle of the Fresnel zone.

The finally selected activity type is sitting, a CIR amplitude value of the region corresponding to the human body reflection path of each type is selected as a first training sample. The CIR amplitude values of the regions numbered as {3, 9, 10, 31}, {18, 20}, {14, 26} are used as the first training sample.

The CIR amplitude values corresponding to the remaining numbered regions are used as a second training sample.

Step 4. The training sample is used to perform transfer learning on the CNN model to obtain a trained CNN model.

The first training sample is used to train the CNN model to obtain initial parameters of the CNN model.

The initial parameters of the CNN model are substituted into the CNN model, parameters of a convolution layer and a pooling layer before a fully connected layer of the CNN model are frozen, and then a certain number of second training samples is selected to form secondary training data to train the fully connected layer of the CNN model, thus obtaining the trained CNN model.

Transfer learning solves the problem of small data samples of human activity recognition, on the other hand, the cost of the whole model training is also reduced without losing the accuracy of activity recognition, moreover, the reusability of human activity recognition system is significantly improved.

The CNN model includes three convolution layers, a pooling layer is connected after each convolution layer, two fully connected layers are connected after the last pooling layer, a Dropout layer is connected after the last fully connected layer, and a softmax layer, which is used for classifying, is connected after the Dropout layer.

The size of a convolution kernel in each convolution layer is 3×3, and an activation function of the convolution layer is Leaky ReLU (Leaky Rectified Linear Unit).

Step 5: An indoor CIR amplitude value is obtained, the CIR amplitude value is input into the trained CNN mode, so as to output a human behavior.

The above is only the preferred embodiments of the present disclosure. It should be noted that for those of ordinary skill in the art, several variations and modifications can be made without departing from the concept of the present disclosure, all of which should be regarded as the scope of protection of the present disclosure.

Those skilled in the art should appreciate that embodiments of the present disclosure may be provided as methods, systems, or computer program products. Thus, the present disclosure may take the form of an entirely hardware embodiment, an entirely software embodiment, or an embodiment combining software and hardware aspects. Moreover, the present disclosure may take the form of a computer program product embodied in one or more computer readable media (including, but not limited to, a disk memory, a CD-ROM (Compact Disk Read Only Memory), an optical memory, etc.) having computer readable program code embodied thereon.

The present disclosure is described herein with reference to flow charts and/or block diagrams of methods, apparatus (systems), and computer program products according to embodiments of the present disclosure. It should be understood that each flow in the flow charts and/or block diagrams, and combinations of flows and/or blocks in the flow charts and/or block diagrams can be implemented by computer readable program instructions. These computer program instructions can be loaded onto a general-purpose computer, a specific-purpose computer, an embedded processor or a processor of another programmable data processing apparatus to produce a machine, so that the instructions executed on the computer or the processor of the other programmable data processing device create a device for performing the functions specified in the flow(s) of the flow charts and/or the block(s) of the block diagrams.

These computer program instructions may also be stored into a computer readable memory capable of directing the computer or the other programmable data processing apparatus to operate in a specific manner, so that the instructions stored in the computer readable memory create manufactures including an instruction device which performs the functions specified in the flow(s) of the flow charts and/or the block(s) of the block diagrams.

These computer program instructions can also be loaded onto the computer or the other programmable data processing apparatus, so that a series of operational steps are performed on the computer or the other programmable data processing apparatus to create a computer implemented process, the instructions executed on the computer or other programmable apparatus provide steps for implementing the functions specified in the flow(s) of the flow charts and/or block(s) of the block diagrams.

What is claimed is:

1. An indoor passive human behavior recognition method, comprising the following steps:
Step 1: dividing an indoor activity space into a plurality of regions, collecting a CIR (channel impulse response) data packet of a reflection signal of each activity in each region to obtain an H (M, N, Z) matrix, wherein M denotes a region number, N denotes a human activity type, and Z denotes the CIR data packet;
Step 2: preprocessing the H (M, N, Z) matrix to obtain a preprocessed H (M, N, Z) matrix;
Step 3: extracting features of the preprocessed H (M, N, Z) matrix to obtain a training sample of a CNN (convolutional neural network) model;
Step 4: performing transfer learning on the CNN model using the training sample, so as to obtain a trained CNN model; and
Step 5: obtaining an indoor CIR amplitude value, inputting the CIR amplitude value into the trained CNN model, and outputting a human behavior.

2. The indoor passive human behavior recognition method according to claim 1, wherein a calculation formula for the CIR is as follows:
H(i)=∥H(i)∥e^{j∠H(i)}
wherein H(i) denotes channel state information of an i-th sub-carrier, μH(i)∥ denotes an amplitude of the i-th sub-carrier, ∠H(i) denotes a phase of the i-th sub-carrier, and j is an imaginary part of a complex number.

3. The indoor passive human behavior recognition method according to claim 1, wherein
an acquisition method for the region number is as follows:
dividing the activity space into M regions with the same area and in a n×n distribution, and starting from the top left corner, numbering the regions in each row from left to right in turn.

4. The indoor passive human behavior recognition method according to claim 1, wherein
Step 2 comprises the following steps:
filtering the CIR data packet of the H (M, N, Z) matrix using hampel, so as to obtain a filtered H (M, N, Z) matrix;
interpolating the CIR data packet of the filtered H (M, N, Z) matrix to obtain an interpolated H (M, N, Z) matrix;
preforming Kalman smoothing filtering on the CIR data packet of the interpolated H (M, N, Z) matrix to obtain a smoothed H (M, N, Z) matrix;
performing wavelet transform on the CIR data packet of the smoothed H (M, N, Z) matrix to obtain a denoised H (M, N, Z) matrix; and
performing data dimension reduction processing on the CIR data packet of the denoised H (M, N, Z) matrix using PCA (Principal Component Analysis), so as to obtain a dimension-reduced H (M, N, Z) matrix.

5. The indoor passive human behavior recognition method according to claim 1, wherein
Step 3 comprises the following steps:
clustering CIR amplitude values of various regions for various activities to obtain n major types;
dividing the M regions for various activities into n major types;
calculating MKMMD (Multiple Kernel Maximum Mean Discrepancy) values of the CIR amplitude values of various regions for each type of activity, and obtaining a number of a region corresponding to the minimum MKMMD value;
acquiring a number of a region corresponding to a human reflection path from the regions corresponding to the minimum MKMMD values in various types of activity according to the wireless sensing principle of a Fresnel zone;
using a CIR amplitude value of the region corresponding to the human reflection path of each type of activity as a first training sample; and
using CIR amplitude values corresponding to the remaining numbered regions for various activities as a second training sample.

6. The indoor passive human behavior recognition method according to claim 1, wherein
Step 4 comprises the following steps:
training the CNN model using the first training sample, so as to obtain initial parameters of the CNN model;
substituting the initial parameters of the CNN model into the CNN model, freezing parameters of a convolution layer and a pooling layer before a fully connected layer of the CNN model, and then selecting a certain number of second training samples to form secondary training data to train the fully connected layer of the CNN model, thus obtaining a trained CNN model.

7. The indoor passive human behavior recognition method according to claim 1, wherein the CNN model comprises three convolution layers, a pooling layer is connected after each convolution layer, output ends of all pooling layers are connected with two fully connected layers after fusion calculation; a Dropout layer is connected after the last fully connected layer, and a softmax layer is connected after the Dropout layer.

8. The indoor passive human behavior recognition method according to claim 2, wherein the CNN model comprises three convolution layers, a pooling layer is connected after each convolution layer, output ends of all pooling layers are connected with two fully connected layers after fusion calculation; a Dropout layer is connected after the last fully connected layer, and a softmax layer is connected after the Dropout layer.

9. The indoor passive human behavior recognition method according to claim 3, wherein the CNN model comprises three convolution layers, a pooling layer is connected after each convolution layer, output ends of all pooling layers are connected with two fully connected layers after fusion calculation; a Dropout layer is connected after the last fully connected layer, and a softmax layer is connected after the Dropout layer.

10. The indoor passive human behavior recognition method according to claim 4, wherein the CNN model comprises three convolution layers, a pooling layer is connected after each convolution layer, output ends of all pooling layers are connected with two fully connected layers after fusion calculation; a Dropout layer is connected after the last fully connected layer, and a softmax layer is connected after the Dropout layer.

11. The indoor passive human behavior recognition method according to claim 5, wherein the CNN model comprises three convolution layers, a pooling layer is connected after each convolution layer, output ends of all pooling layers are connected with two fully connected layers after fusion calculation; a Dropout layer is connected after the last fully connected layer, and a softmax layer is connected after the Dropout layer.

12. The indoor passive human behavior recognition method according to claim 6, wherein the CNN model comprises three convolution layers, a pooling layer is connected after each convolution layer, output ends of all pooling layers are connected with two fully connected layers after fusion calculation; a Dropout layer is connected after the last fully connected layer, and a softmax layer is connected after the Dropout layer.

13. An indoor passive human behavior recognition device, comprising the following modules:
a collection module, configured to divide an indoor activity space into a plurality of regions, collecting a CIR data packet of a reflection signal of each activity in each region to obtain an H (M, N, Z) matrix, wherein M denotes a region number, N denotes a human activity type, and Z denotes the CIR data packet;
a preprocessing module, configured to preprocess the H (M, N, Z) matrix to obtain a preprocessed H (M, N, Z) matrix;
a training sample acquisition module, configured to extract features of the preprocessed H (M, N, Z) matrix to obtain a training sample of a CNN model;
a CNN training module, configured to perform transfer learning on the CNN model using the training sample, so as to obtain a trained CNN model; and
a behavior recognition module, configured to obtain an indoor CIR amplitude value, input the CIR amplitude value into the trained CNN model, and output a human behavior.
